(19) United States
(12) Patent Application Publication
(10) Pub. No.: US 2021/0350657 A1
(43) Pub. Date: Nov. 11, 2021

(54) WAGERING GAME MACHINES WITH COORDINATED CONTENT DISPLAYS

(71) Applicant: Eye-Fi, LLC, Las Vegas, NV (US)

(72) Inventors: Scott Allen Clear, Escondido, CA (US); Marcelo Mascarenhas Kertesz, Encinitas, CA (US)

(21) Appl. No.: 16/867,886

(22) Filed: May 6, 2020

(51) Int. Cl. G07F 17/32

(52) U.S. Cl. CPC G07F 17/3216; G07F 17/3258; G07F 17/3223

(57) ABSTRACT

A system includes first game machine with a first main display and a second game machine with a second main display organized in a bank of game machines. The system also includes an upper signage display, at least one other display (e.g., a filler display, an edge display, and an end cap display), and a chair display of a first gaming chair associated with the first game machine. The chair display, the upper signage display and the at least one other display form a first cumulative display area. The first cumulative display area is configured to present first content at a first time, and present second content at a second time. The second content is coordinated with a second cumulative display area of a separate bank of game machines.

### BACKGROUND

Gaming machines or game machines, such as wagering game machines (e.g., slot machines, virtual or video poker, virtual or video roulette) are a large part of the gaming industry. For example, casinos may profit more from wagering game machines (e.g., slot machines, virtual or video poker, virtual or video roulette) than traditional table games. Players may play a wagering game for various reasons including the actual or perceived value such as visual appeal, entertainment value, likelihood of winning, etc. The most popular games may be the games a player is most likely to be attracted to or that provide the most value.

### SUMMARY

The present disclosure provides new and innovative systems and methods for coordinating content display across multiple wagering game machines and/or banks of game machines. In an example, a gaming chair associated with a game machine includes a seat, a backrest, and a first display. The backrest has a front surface and a rear surface and the front surface faces a game machine. The first display is positioned on the rear surface of the backrest. Additionally, the first display is configured to present first content on the first display at a first time, and present second content on the first display at a second time. The second content is coordinated with a second display of the game machine.

In another example, a system includes a first game machine of a plurality of game machines organized in a bank and a second game machine of the plurality of game machines organized in the bank. The first game machine and the second game machine include a first main display and a second main display, respectively. The system also includes an upper signage display and at least one of a filler display, an edge display, and an end cap display. Additionally, the system includes a first gaming chair associated with the first game machine. The first gaming chair includes chair display. The chair display, the upper signage display and the at least one of the filler display, the edge display, and the end cap display form a first cumulative display area. The first cumulative display area is configured to present first content at a first time, and present second content at a second time. The second content is coordinated with a second cumulative display area of a separate bank of game machines.

In another example, a method includes receiving an instruction to present dynamic content and presenting the dynamic content along a track on a first cumulative display area. At least two of a chair display, a secondary display, an upper signage display, a filler display, and an end cap display form the first cumulative display area. The method also includes filtering the dynamic content as it passes through a distraction zone of the first cumulative display area. Additionally, the method includes presenting the dynamic content on a second cumulative display area according to a content flow path.

Additional features and advantages of the disclosed systems and methods are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE FIGURES

FIGS. 1A and 1B illustrate perspective views of banks of gaming machines according to example embodiments of the present disclosure.

FIG. 2 illustrates a side view of a bank of gaming machines according to an example embodiment of the present disclosure.

FIG. 3A illustrates a block diagram of content on a full content area according to an example embodiment of the present disclosure.

FIG. 3B illustrates a block diagram of content on a cumulative display area according to an example embodiment of the present disclosure.

FIG. 3C illustrates a block diagram of content following a content track on a full content area according to an example embodiment of the present disclosure.

FIG. 3D illustrates a block diagram of content following a content track on a cumulative display area according to an example embodiment of the present disclosure.

FIG. 4 illustrates a layout of a system of game machines and associated content flow paths according to an example embodiment of the present disclosure.

FIG. 5 illustrates a system of game machines according to an example embodiment of the present disclosure.

FIG. 6 illustrates an exploded view of a game chair according to an example embodiment of the present disclosure.

FIG. 7 illustrates a flow chart of an example process for coordinating content display across multiple wagering game machines according to an example embodiment of the present disclosure.

### DETAILED DESCRIPTION OF EXAMPLE EMBODIMENTS

Techniques are disclosed for coordinating the presentation and display of content across multiple wagering game machines and/or banks of game machines. Typically, wagering game machines include negative space or dead space that is occupied by a chair, structural components of a cabinet for the game machine or bank of game machines, and other non-display surfaces. Additionally, the main display of a game machine is often dedicated solely to game related content and is typically obstructed or blocked from other patrons when the game machine is occupied by a participant or player. To reduce the negative or dead space associated with wagering game machines, additional displays may be provided on the game machine or bank of game machines and content may be coordinated and synchronized across the various displays to enhance the advertising value, entertainment value, and attractiveness of the game machines. Furthermore, the displays may be LED panel displays that advantageously allow the displays to take on the form of various different shapes, sizes and curves. For example, multiple LED panel displays can be daisy-chained together to form a continuous curved display.

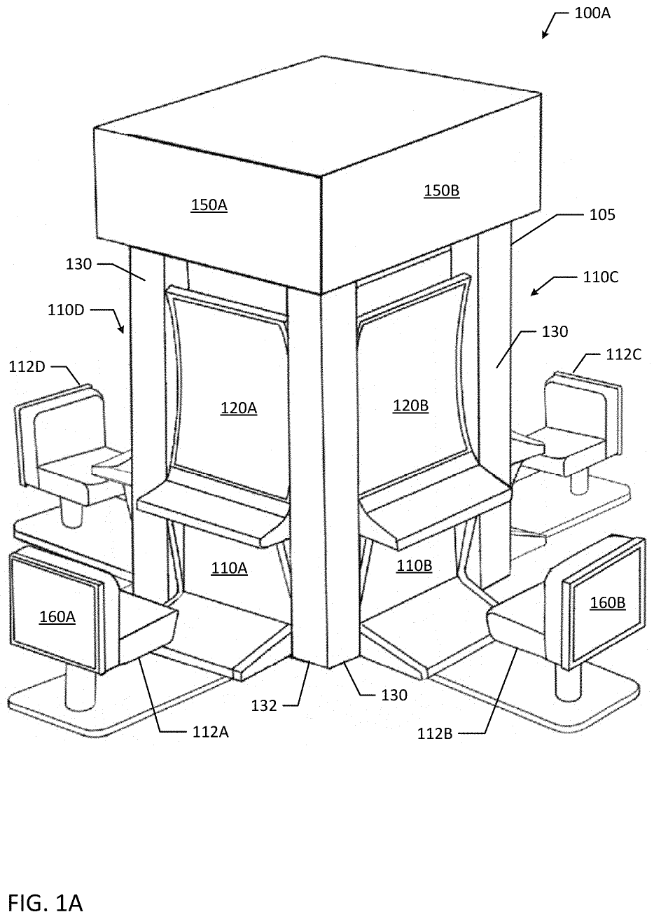

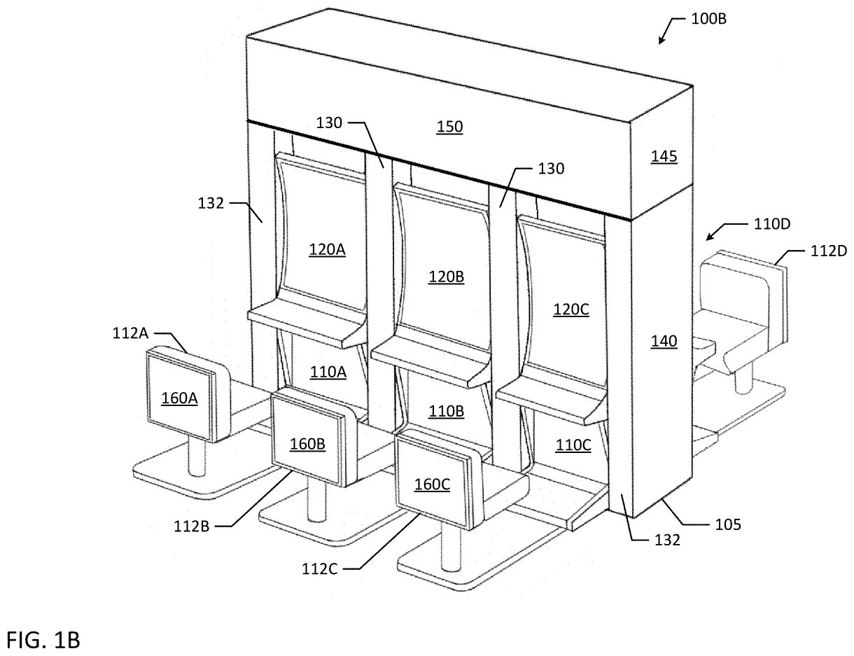

In an example, a plurality of game machines may be arranged in a bank of game machines. For example, FIG. 1A illustrates a bank 100A of game machines 110A-D. A bank of game machines may also be referred to as a pod of game machines. FIG. 1B illustrates a bank 100B (e.g., 3×2 bank) of game machines 110A-F (note game machines 110E-F are not pictured). The game machines 110A-F, hereinafter referred to generally as game machine(s) 110, are operable to conduct wagering games (e.g., slot-based wagering games). The banks 100A-B, hereinafter referred to generally as bank(s) 100, of game machines 110 may include a cabinet or housing 105 enclosing each game machine 110 of the bank 100.

The game machines 110 may be electronic game machines (“EGMs”) and/or personal game devices. In an example, an EGM may be a slot machine, a video poker machine, a video keno machine, a video bingo machine, a video lottery machine, or any other wagering game machine. Game machines 110, such as EGMs, are notably different from general computing devices and display devices.

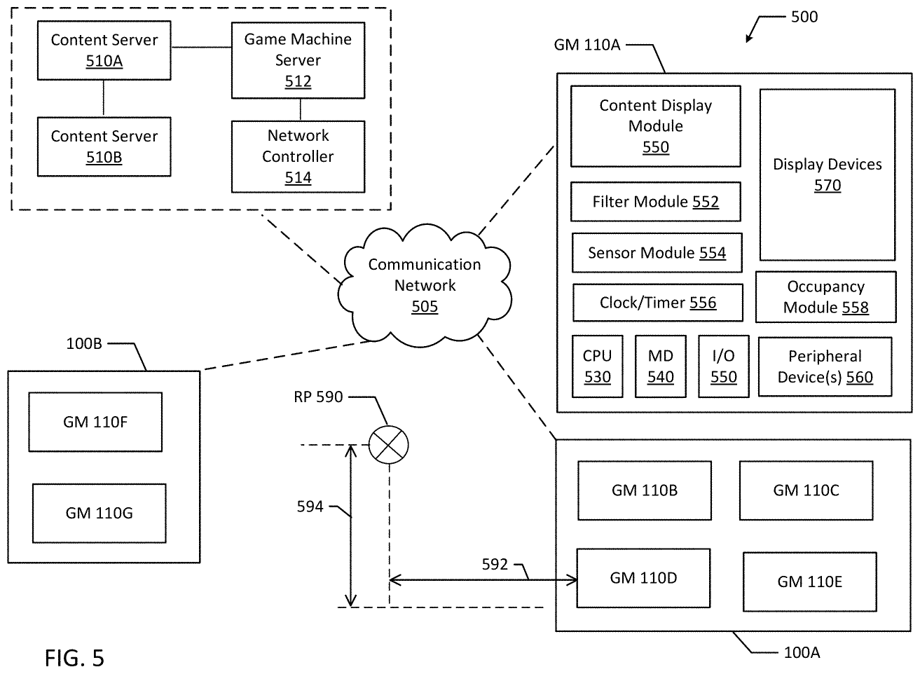

For example, referring to FIG. 5, the game machines 110 (e.g., EGMs) may include unique interfaces and I/O interfaces 550, such as serial interfaces, to connect to specific subsystems (e.g., serial devices) internal and external to the game machine 110. The game machines 110 (e.g., EGMs) may also connect to peripheral devices 560. Certain game machines 110 (e.g., EGMs) may be treated as peripheral devices to a network controller 514 or server (e.g., content server 510A-B and game machine server 512) and connected in a shared daisy-chain fashion to a single serial interface. The peripheral devices 560 may be assigned device addresses and serial controller circuitry may generate or detect unique device addresses. Typically, general purpose computing device serial ports may not be able to do this.

As mentioned above, the peripheral devices 560 associated with the game machines 110 are not typically used for general purpose computing devices. For example, the peripheral devices 560 associated with the game machines 110 may include bill and coin validators, coin and ticket dispensers, ticket or coupon printers, player card readers etc. Player card readers may identify a player card and access a player account using the player card. These peripheral devices 560 are used to control and govern the input and output of monetary value to and from the game machine 110. Furthermore, because the game machines 110 are configured to award up to multiple millions of dollars of monetary value to game winners, the game machines 110 are highly regulated and often times hardware and/or software architectures are implemented in the game machines 110 that differ significantly from those of general purpose computing devices.

It should be appreciated that the serial interfaces and serial devices associated with the game machines 110 may have electrical interface requirements that differ from the standard interfaces provided by general purpose computers or general purpose computing devices. The serial interfaces may be used to transmit information using communication protocols that are unique to the gaming industry. Additionally, it should be appreciated that the game machines 110 differ from general purpose computing devices in that the game machines 110 are state-based systems that store an maintain their current state in non-volatile memory (e.g., MD 540) such that the machines may return to that state in the event of a malfunction or power failure. Conversely, general purpose computing devices may not be state-based machines, and as a result, data is typically lost when a malfunction occurs.

Another difference between game machines 110 (e.g., EGMs) and general purpose computing devices is that the software on the game machine may be static (e.g., non-changeable) and monolithic to prevent cheating by a participant or player. For example, the static coding instructions on an EPROM of the game machine 110 are approved by gaming regulators whereas such regulations and software requires are not present for general purpose computing devices. In addition to having static (non-changeable) software, the game machines 110 may also be configured to authenticate the code to ensure that the code is unaltered before executing the code. In an example, a game machine 110 may hash the game program code using a hash function to obtain a result and then compare that result to an authentication value.

Trusted memory devices (e.g., MD 540) and/or trusted memory sources may be included in the game machines 110 (e.g., EGMs) or associated with the game machines 110 (e.g., EGMs) to ensure the authenticity of the software, which may otherwise be stored on less secure memory subsystems, such as mass storage devices. Typically, memory devices 540 such as mass storage devices used in a general purpose computing devices enable code and data to be read from and written to the mass storage device. However, trusted memory devices 540 and controlling circuitry are designed to prevent modification of the code and data stored in the memory device 540 while the memory device 540 is installed in the game machine 110. The code and data stored in these devices may include authentication algorithms, random number generators, authentication keys, operating system kernels, etc. The trusted memory devices 540 advantageously provide gaming regulatory authorities a root trusted authority within the computing environment of the game machines 110 (e.g., EGMs) that can be tracked and verified as original.

Additionally, game machines 110 (e.g., EGMs) storing trusted information may detect and prevent tampering, for example, by using encryption to prevent misuse. Tampering may be detected through one or more sensors or sensor module(s) 552, which may be coupled to the memory device 540.

Therefore, it should be appreciated that adapting general purpose computing device technologies or display device technologies to the gaming industry and game machines 110 (e.g., EGMs) is a complicated and difficult task due to security requirements, regulatory requirements, fault tolerance requirements, etc. Additionally, many of the techniques or solutions that may be applied to general purpose computing devices and display devices associated with connectivity, communication, and compatibility are often inadequate for game devices and machines 110.

Referring back to FIGS. 1A and 1B, each game machine 110 may be associated with a game chair 112A-D of FIG. 1A and game chair 112A-F of FIG. 1B (note game chairs 112E-F are not pictured). In operation, players may purchase a “play” of the game on game machines 110 and during a “play” of the game, the game machine 110 generates one or more random events and provides an award(s) for winning outcomes of the one or more random events.

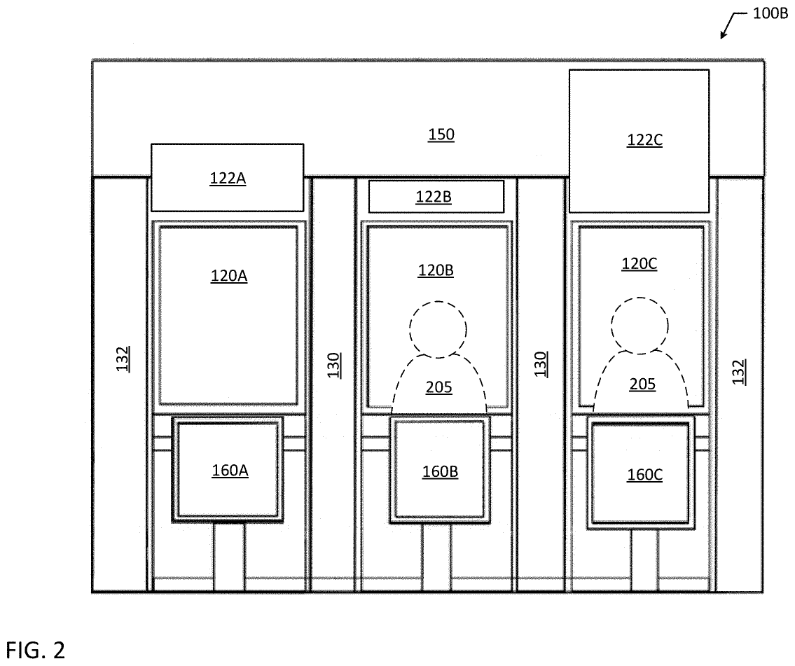

The game machines 110 may include a primary display 120 (e.g., curved J-screen), an optional secondary display 122 (e.g., topper) shown in more detail in FIG. 2, and accent display(s). The accent display(s) may include light rings, light strips, LED bars, marquee lights, string lights, laser projectors, etc. For example, FIG. 2 illustrates three different toppers 122A-C. Additionally, the bank 100 of game machines 110 may include filler displays 130, edge displays 132, end bank displays 140 and upper signage displays 150A-B, hereinafter referred to generally as upper signage display 150. Furthermore, each game chair 112 may include a chair display 160. Each of the displays may be referred to without the term “display” (e.g., upper signage display 150 may be referred to as upper signage 150 and filler displays may be referred to as simply fillers).

Edge displays 132 may function similarly as filler displays 130 or as end bank displays 140. For example, the end bank displays 140 may wrap around to include edge displays 132. Similarly, display(s) 145 may be part of the upper signage 150 such that the upper signage 150 wraps around the entire bank 100B of game machines. In another example, the display(s) 145 may be part of the end bank displays 140. The display(s) 145 may also function independently of both the end bank displays 140 and upper signage 150. The various displays are positioned about the game machine 110, which advantageously reduces the negative space or dead space that would otherwise typically be associated with game machines. By reducing the negative space or dead space with additional displays, the game machines 110 or banks 100 of game machines are adapted to provide additional content to patrons.

The primary display 120, optional secondary display 122, filler display 130, end bank display 140 and/or upper signage 150 may display content such as game content or non-game content. Additionally, the content may be static or dynamic. Game content may include the display of one or more video reels, one or more video wheels, and/or one or more video dice. The content may include information associated with wagering games (e.g., game help information or game play instructions), non-wagering games, community games, player attraction material, product or service advertisements (e.g., advertisements for restaurants, shows, concerts or other events), premium entertainment, bonus information, alerts or announcements, broadcast information, subscription information, atmosphere or theme information (e.g., theme associated with a particular casino), etc. The content may be presented as images, symbols, indicia, etc. For example, the display devices are adapted to display or present visual representations or exhibitions of static objects or images as well as the movement of objects, video images, dynamic lighting, etc. Game content may include the display of one or more video reels, one or more video wheels, and/or one or more video dice.

The primary display 120, optional secondary display 122, filler display 130, edge display 132, end bank display 140, displays 145, upper signage 150 and/or chair display 160 may each include a liquid crystal display (LCD), a light emitting diode (LED) display, a plasma display, a DLP projection display, an electroluminescent (EL) panel, a cathode ray tube (CRT) or any other type of display suitable for use in the game machine 110.

In an example, the upper signage 150 may be made up of panels that are daisy-chained together. Additionally, even though upper signage 150 in FIG. 1A is illustrated as being square shaped with four flat sides, the upper signage 150 may be curved and may form a continuous curved display from several panels daisy-chained together in a circular or oval shape. For example, the upper signage 150 may be made up of 16-inch panels daisy-chained together. The chair display 160 may be an 18-inch by 18-inch panel made up of several 3-inch by 9-inch panels.

Typically, the primary display 120 may portray the random event and the outcome of the random event to the player. In an illustrative example of a reel slot game, the primary display 120 may include representations of reels with multiple items. Each reel may spin until a random item is portrayed on a payline or paylines. In an example, the primary display 120 may be a touch screen to facilitate interaction with the player. Portrayed outcomes (e.g., reel items portrayed on the paylines) may be winning outcomes or losing outcomes. A winning outcome may result in additional information being displayed on one or more of the primary display 120, optional secondary display 122, filler display 130, end bank display 140 and/or upper signage 150.

Each game chair 112A-F, hereinafter referred to generally as game chair(s) 112, is located near a corresponding game machine 110. For example, a game chair 112 may be located in operational proximity of a respective game machine 110. Referring to the back of the game chair 112, the chair display 160 may be positioned near the top of the chair to provide additional visibility to other potential players. In an example, the chair display 160 may also be an interactive touch screen.

As discussed above, the display 160 may provide information associated with the wagering game, such as the portrayed outcomes displayed on primary display 120. For example, as illustrated in FIG. 2, a player's body 205 may block a large portion of the primary display 120 while seated in game chair 112. Blocking a large portion of the primary display 120 may reduce the appeal of the game machine 110 to other potential players. By similarly displaying the portrayed outcomes on the chair display 160, the same content can be provided to additional potential players without being blocked by the current player's body 205. The chair display 160 may provide other player attraction material.

The secondary displays 122 may be positioned above the primary display 120 of a gaming machine 110. As illustrated in FIG. 2, the secondary displays 122 may partially overlap upper signage 150. Conversely, the secondary display 122 may sit entirely below upper signage 150. In other examples, the primary display 120 may extend to the upper signage 150 without a secondary display 122.

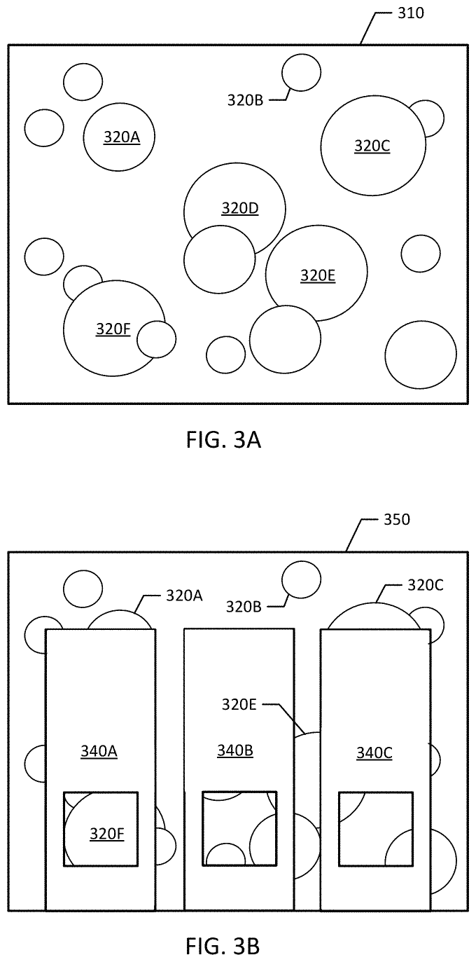

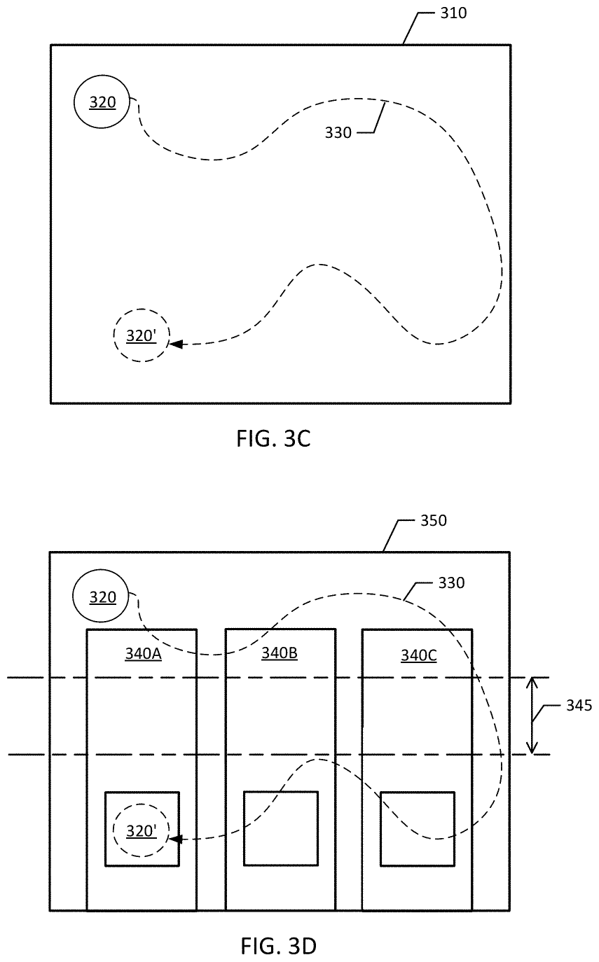

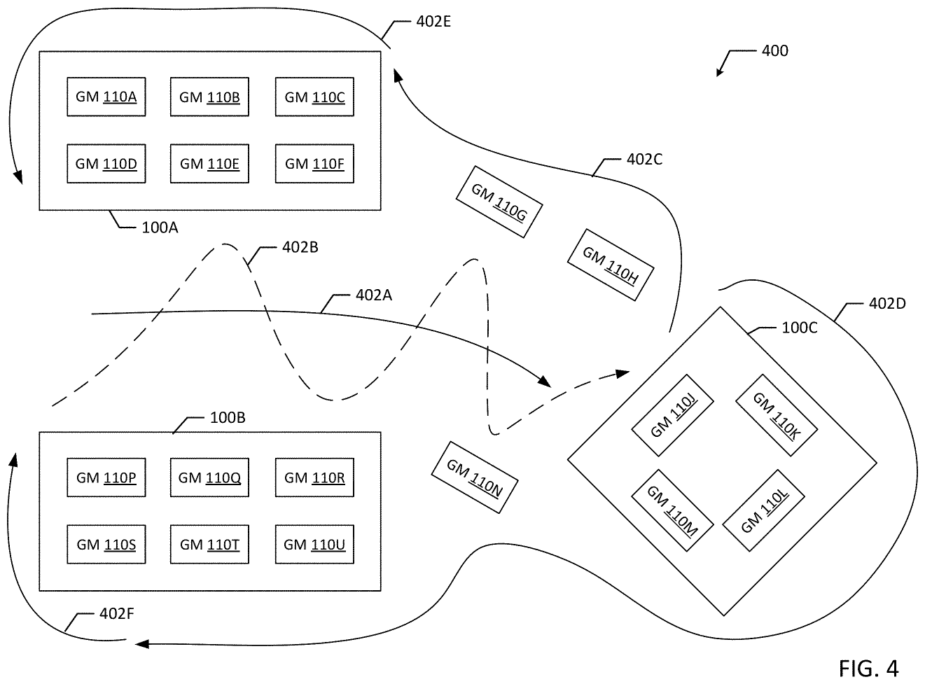

FIG. 3A illustrates example of a full content area 310 that could be provided on a display the same size as a bank 100 of game machines 110. In the illustrated example, FIG. 3A illustrates an example of the full content area 310 that could be provided on a display similarly sized and shaped as one side of the bank 100 of game machines 110 illustrated in FIG. 2. The full content area 310 may include individual content items 320A-F, hereinafter referred to as content items or content 320. The content items may be static or stationary or dynamic (as described in more detail in FIGS. 3C, 3D and 4).

FIG. 3B illustrates an example of the content mapped to a cumulative display area 350 that is created from the various displays working together (e.g., display created by upper signage 150, fillers 130, edge displays 132, displays 145, end banks 140, and chair displays 160) and taking into account the dead space 340A-C of the game machine 110. The dead space 340A-C may include the main display(s) 120 and any other portion of the bank 100 of game machines that is unable to display content. In some examples, the main display 120 may be unavailable to provide additional content and may be controlled entirely by the game “owner”. In other examples, the main display 120 may be included as part of the cumulative display. For example, by coordinating content between each of the main display 120, upper signage 150, fillers 130, edge displays 132, displays 145, end banks 140, and chair displays 160, each individual display works together to create the illusion of a single larger screen. Together, the displays generate a single virtual screen to create a theatrical experience.

Cumulative displays 350 from several banks 100 of game machines 110 may also form a single cumulative display 350. For example, referring to FIG. 4, the cumulative display 350 may be the display created from each of banks 100A-C and GM 110G, 110H and 110N. Additionally, a cumulative display 350 may be formed from various sides of banks 100 and game machines 110. For example, the front side of bank 100A (e.g., side with GM 110D-F) and GM 110G-H may form a cumulative display 350.

The display devices of the game machine 110 (e.g., EGM) are configured to display content such as game content or non-game content. In one embodiment, the gaming system causes at least one display device of an EGM and/or personal game device to display a game, a game related animation, an advertisement, etc. In an example, the gaming system causes one or more of the display devices to display a coordinated animation with respect to one or more of the other display devices.

FIGS. 3C and 3D illustrate an example of a content track 330 (e.g., for dynamic content) of a content item 320. In an example, the content track 330 may be based on the layout of the cumulative display area 350 and the position of the dead space 340A-C. For example, the content track 330 may be adapted to pass through a limited amount of dead space 340A-C, hereinafter generally referred to as dead space 340. For example, the content track 330 may have a track length and the portion of the track length within the dead space 340 may be limited to a predetermined threshold amount (e.g., less than 20 percent of the track length). In other examples, the content track 330 may also be associated with a constant or variable content speed. In an example, the content track 330 may be adapted such that the content item 320 spends less than a predetermined amount of time within the dead space 340A-C (e.g., less than 10 or 20 percent of time within the dead space 340A-C), which advantageously ensures that the content is visible to patrons for the majority of the time the content is being displayed along the content track 330.

The content track 330 may also be adapted to avoid or minimally occupy a distraction zone 345. For example, the distraction zone 345 may be a portion of the cumulative display area 350 that is near eye-level of a player that may cause such that if a content item 320 is displayed in the distraction zone 345, the content item 320 may distract the player from the wagering game. To further avoid distracting players, filtering may be implemented to filter content as it passes through the distraction zone 345. Filtering content may include dimming the content 320 (e.g., reducing the brightness of the content) or detuning the content 320 as it passes through the distraction zone.

For example, each game machine 110 or bank 100 may include a filter module (e.g., filter module 552 of FIG. 5) that is configured to perform filtering based on a specific filtering criteria such that a specific portion of selected information or a subset of information (e.g., content 320) is displayed on the one or more displays of the bank 100 of game machines 110. The type of content 320 and the amount of content 320 provided on the game machines 110 may also be based on how full the system or bank 100 of game machines 110 is (e.g., the occupancy rate of the bank 100). For example, each game machine may also include a user identification module or occupancy module (e.g., occupancy module 558 of FIG. 5) to determine whether a game machine is occupied by a player. In an example, the type of content or content flow path (described in more detail below) may be based on the occupancy. For example, if each of the wagering games are occupied, the content or content flow path may be used for advertising or other type of entertainment. Conversely, if the game machines 110 are less occupied, the content or content flow path may be adapted to attract patrons to the game machines 110 in an effort to increase participation. For example, to increase occupancy, the game machines 110 may present content 320 in an “attract” mode that presents a specific type of content 320 along a track 330 or content flow path (e.g., flow paths 402 of FIG. 4) designed to attract additional casino patrons to participate in game play.

In an example, sensors or sensor module(s) (e.g. sensor module 554 of FIG. 5) such as optical sensors, pressure sensors, image sensors, biometric sensors, etc. may be used to determine occupancy or the density of patrons near a specific game machine, bank of game machines 100 or within an area of a system of game machines 110. Based on the occupancy or density of patrons, content 320, content tracks 330 and content flow paths (e.g., flow paths 402 of FIG. 4) may be adjusted accordingly.

Referring collectively to FIGS. 3A-D, in one illustrative example, content items 320A-F may be representations of coins that follow tracks 330 to produce the effect of trickling down the cumulative display area 350. For example, during a winning outcome or a jackpot on a game machine 110 within a system of game machines 110 or a bank 100 of game machines, the cumulative display area 350 may present a shower of coins that trickle down from the upper signage 150, down the filler displays, end caps and chair displays until reaching the ground. Each content item 320A-N (e.g., representation of a coin) may follow its own track 330 and trickle down the cumulative display area 350 at its own rate and direction (e.g., at differing velocities). In an example, as content items 320 pass through the distraction zone, the content items may be presented at a lower brightness level so as to avoid distracting patrons playing on the game machines 110. By displaying the “jackpot” event across the entire bank 100 of game machines 110 or to multiple game machines 110 or banks 100 within a system, other patrons may be enticed to participate and play on open machines.

Instead of a “trickle” down effect, the game machines 110 in the bank 100 of game machines may collectively present effects such as light washes or chases from one side of the bank to the other side of the bank (e.g., top to bottom, bottom to top, left to right, or right to left). The bank 100 of game machines may also collectively present coordinated content with a radiating outward or radiating inward effect. For example, similar to the “jackpot” scenario above, the game machine 110 associated with the winning outcome or “jackpot” may be the central focus of the effect where the content items 320 (e.g., representations of coins) radiate out and explode away from that game machine 110. For example, referring back to FIG. 2, if the player sitting in the chair associated with chair display 160B were to win a “jackpot”, the chair display 160B may serve as the central focus of the effect and the content items 320 may explode away from the chair display 160B radiating outwards to all edges of the cumulative display area 350. In another example, the chair display 160B may instead serve as a the central focus of a radiating inward effect where the content items 320 rush in from all edges of the cumulative display area 350 towards the chair display 160B as if the player was a magnet collecting all of the coins.

The content 320 may be presented in a forced perspective where the content 320 hits multiple displays at the same time or in succession. Additionally, the content 320 may be presented as micro content on an individual display (e.g., chair display 160) or as macro content across an entire cumulative display area 350 of a bank 100 of game machines or a network of banks 100 of game machines.

The game machines 110 may also include one or more audio speakers that emit sound in conjunction with the content 320 presented on the various displays. In some examples, other devices may further augment the content with vibrations or other tactile feedback.

The coordinated presentations can be a celebration presentation following a win (as described above), a game themed or casino-related environmental presentation, and may be adapted to attract or bring attention to the bank 100 of game machines 110. Additionally, the content on the various displays may assist a patron in finding a specific game machine 110, help draw a patron into different areas of a casino, or may provide additional information to a patron such as a venue location, an event time, etc. Content items may be advertisements, such as advertisements for restaurants, shows, concerts or other events taking place nearby or at the casino. For example, a content item 320 may be a restaurant logo that follows a track 330 in a direction towards that restaurant. The track 330 may be configured to provide directional instructions to a viewer. Portions or all of the cumulative display area 350 (e.g., chair displays 160) may be sold or leased to different advertisers.

In another example, the cumulative display may present game related theme material or entertainment material that augments the game experience. For a game that is racecar or racetrack themed, the cumulative display area 350 may present additional content items 320 (e.g., checkered flags, race cars, tires, pit stops, etc.) such that an entire bank 100 of game machines 110 appear to be a single cohesive gaming experience. The game related theme material may also attract other patrons who may otherwise have trouble seeing game themes that are blocked by patrons at occupied games.

FIG. 4 illustrates various content flow paths 402A-D along a system 400 of game machines 110. For example, content items 320 may move along predetermined content tracks 330 along each bank 100 of game machines and the content items may also follow a flow path 402 along other banks 100 of game machines. As illustrated in FIG. 4, content 320 may follow flow path 402A and may stream along both sides of banks 100A and 100B and continuing on the game machines 110G, 110H and 110N before reaching bank 100C where it is displayed on the bank near game machine 110J. In this example, the flow path 402A may create a tunnel effect where the content is tunneled towards bank 100C.

Similar to the content tracks 330, the flow paths 402 may be determined based on the location of a game event (e.g., game machine location of a “jackpot”) or based on the flow of a game theme animation. For example, if a participating occupying game machine 110J of FIG. 4 wins a “jackpot”, a similar coin animation may follow flow path 402A as well as the reverse direction of 402E, 402C, 402F and 402D to collectively present coordinated content 320 with a radiating inward effect. For example, the game machine 110J associated with the winning outcome or “jackpot” may be the central focus of the effect where the content items 320 (e.g., representations of coins) flow in along the game machines 110 towards game machine 110J as if the player was a magnet collecting all of the coins. In another example, for a radiating outward effect, the content 320 may follow the flow paths of 402C, 402D and the reverse of 402A simultaneously to create a coordinated display of coins exploding away from the winner.

In another example, a flow path 402 may bounce back and forth between banks 100 and game machines 110. Flow path 402B may create a winding river or winding path effect, like a ball bouncing back and forth between banks 100 and/or game machines 110, where content winds along the flow path towards bank 100C. This type of path may increase the amount of content 320 that a single patron consumes as the flow path 402A is longer than flow path 402B. In the example of a game themed content, specifically the racecar or racetrack example, the content 320 may follow content flow path 402B and may present and animation of a racecar passing several other racers on both sides before reaching the finish line at bank 100C.

Flow path 402A may be better suited to entice patrons to ultimately travel to bank 100C while flow path 402B may be better suited to attracting patrons to participate in game machines at banks 100A-B or individual game machines 100G, 100H or 100N along the way. After reaching bank 100C, the flow path 402 may split and display content along two different paths 402C and 402D simultaneously around the back sides of the banks 100 and game machines 110. The content may then be wrapped back around the game machines along flow paths 402E and 402F where it may start again along either of flow paths 402A or 402B to continuously attract patrons and provide content along the entire system of game machines.

As illustrated in FIG. 5, a wagering game system 500 of the present disclosure may include one or more game machines 110 or banks 100 of game machines and one or more servers (e.g., content server 510A-B and game machine server 512) and/or controllers (e.g., network controller 514). The game machines 110 are configured to communicate with (e.g., content server 510A-B and game machine server 512) and/or controllers (e.g., network controller 514) through a data network, such as communication network 505 or remote communication link. The game machines 110 may also communicate with other game machines 110 or banks 100 of game machines 110.

Each game machine 110 includes a processor (e.g., CPU 530) configured to transmit and receive data or signals (e.g., content data) representing instructions, commands, messages, etc. between the game machine 110 and one or more of the servers (e.g., content server 510A-B and game machine server 512) and/or controllers (e.g., network controller 514). Additionally, the processor 530 of the game machine 110 is configured to execute the instructions, commands, messages, etc. represented by the data (e.g., to display the appropriate content) on the game machine 110. For example, instructions may be communicated to a content display module 550, which determines what content is displayed on the various display devices 570 associated with the game machine 110.

As used herein, physical processor, processor or CPU 530, refers to a device capable of executing instructions encoding arithmetic, logical, and/or I/O operations. In one illustrative example, a processor may follow Von Neumann architectural model and may include an arithmetic logic unit (ALU), a control unit, and a plurality of registers. In a further aspect, a processor may be a single core processor which is typically capable of executing one instruction at a time (or process a single pipeline of instructions), or a multi-core processor which may simultaneously execute multiple instructions. In another aspect, a processor may be implemented as a single integrated circuit, two or more integrated circuits, or may be a component of a multi-chip module (e.g., in which individual microprocessor dies are included in a single integrated circuit package and hence share a single socket). A processor may also be referred to as a central processing unit (CPU).

As discussed herein, a memory device 540 refers to a volatile or non-volatile memory device (but typically refers to non-volatile memory devices suitable for the wagering game environment), such as RAM, ROM, EEPROM, or any other device capable of storing data. As discussed herein, I/O interface(s) or device(s) 550 refers to a device capable of providing an interface between one or more processor pins and an external device capable of inputting and/or outputting binary data.

Processors (e.g., CPU 530) may be interconnected using a variety of techniques, ranging from a point-to-point processor interconnect, to a system area network, such as an Ethernet-based network. Local connections within each game machine 110, including the connections between a processor (e.g., CPU 530) and a memory device 540 may be provided by one or more local buses of suitable architecture, for example, peripheral component interconnect (PCI).

The game machines 110 and/or banks 100 of game machines 110 are configured to communicate with the servers (e.g., content server 510A-B and game machine server 512) and/or controllers (e.g., network controller 514) or other game machines 110 through a data network, such as communication network 505. In an example, the data network is a local area network (“LAN”), a wide area network (“WAN”), an internet or intranet. In another example, the game machines may communicate with the servers (e.g., content server 510A-B and game machine server 512) and/or controllers (e.g., network controller 514) or other game machines 110 via a direct communication link. In an example, the direct communication link may be a data transmission line, a coaxial cable connection, a fiber optic connection, a wireless or wired routing device, a mobile communication network (e.g., cellular network), etc. Communication over the data network or the direct communication link may utilize a communication protocol or other transmission protocol such as Netplex, USB, Serial, Ethernet, Firewire, I/O debounder, PCI, TCP/IP, 802.11 (WiFi), 802.15 (including Bluetooth™), 802.16 (WiMax), 802.22, cellular standards such as CDMA, Radio Frequency (e.g., RFID), infrared, and Near Field Magnetic communication protocols.

Each game machine 110 and/or bank 100 of game machines may also include a memory device 540, input/output devices or interfaces 550, peripheral devices 560. Additionally, each game machine 110 and/or bank 100 of game machines 110 may include a filter module 552, a sensor module 554, a clock/timer 556, and an occupancy module 558.

As described above, the filter module 552 may filter content 320 as it passes through the distraction zone 345 to avoid distracting game participants or players. For example, the filter module 552 may dim content 320 on display devices 570 within the distraction zone 345. Additionally, the filter module 552 may perform filtering based on a specific filtering criteria such that a specific portion of selected information or a subset of information (e.g., content 320) is displayed on the one or more displays of the bank 100 of game machines 110.

Additionally, the sensor module(s) 554 may include optical sensors, pressure sensors, image sensors, biometric sensors, etc. For example, the sensor module(s) 554 may be used to determine occupancy or the density of patrons near a specific game machine 110, bank of game machines 100 or within an area of a system of game machines 110. Based on the occupancy or density of patrons, content 320, content tracks 330 and content flow paths 402 may be adjusted accordingly. For less occupied banks 100, content 320 may be selected to attract patrons to play the games. For high traffic areas with high occupancy, content 320 may be selected to provide advertisements or other information to patrons.

The clock/timer 556 of the game machine 110 may be used to help synchronize and coordinate content 320 between game machines 110. For example, game machines 110 may present content 320 based on a position-based time delay to ensure that the content 320 is displayed across the appropriate displays at the appropriate times to achieve the desired presentation effect across the bank 100 or across the various banks 100 and individual game machines 110 within the system. The clock/timer(s) of each game machine 110 may be synchronized such that position-based time delays are properly calculated for each game machine 110.

Referring collectively to FIGS. 4 and 5, in some embodiments, to coordinate presentation of content across the bank 100 of game machines 110, each game machine 110 may provide position or location information to the various servers and controllers. For example, the sensor module(s) 554 may provide position or location information based on its position within the bank 100 of game machines 110 or its position relative to a reference point (e.g., RP 590) in a layout of game machines. In an example, a game machine 110 (e.g., GM 110N of FIG. 4) may serve as the reference point in the layout of game machines 110. When displaying content that follows a track 330 or a content flow path 402, a position-based time delay may be determined such that the content 320 is displayed across the appropriate displays at the appropriate times to achieve the desired presentation effect across the bank 100 or across the various banks 100 and individual game machines 110 within the system.

The position of each game machine 110 or bank 100 of game machines 100 in relation to the reference point (e.g., RP 590) may be determined by sensors (e.g., sensor module(s) 554) within each game machine 110. In another example, the layout of the game machines 110 may be predetermined and the position of each machine may be determined (e.g., measured) with respect to a reference point. For example, an “X” measurement 592 and a “Y” measurement 594 may be taken for each game machine 110 in relation to the reference point (e.g., RP 590), which may be incorporated into the programming and content instructions provided to each game machine 110. For example, positional spacing information may be input for one or more of the game machines 110 or may be pre-programed as part of the content instructions. Based on the distances between each game machine 110, and the velocity, acceleration, direction, etc. of the content 320, the content 320 may be presented with the appropriate position-based time delay.

The specific position-based time delay instructions may be handled by the various servers and controllers and sent as part of the instructions to each of the game machines 110. In another example, the specific position-based time delays may be determined by each game machine 110 and the presentation may be achieved using the clock/timer 556 of each game machine 110.

In an example, each of the servers (e.g., content server 510A-B and game machine server 512) may be associated with a respective controller that communicates with the game machines 110 or other controllers/servers via the communication network 505. The game machine server 512 may be configured to control each of the game machines 110. The game machine server 512 may also communicate with the content servers 510A and 510B to manage and control the presentation of content on each of the game machines 110. For example, the game machine server 512 may generate game results and communicate the game results to the game machines 110. The content servers 510A-B may provide content such as game content or non-game content to the game machines 110. For example, content server 510A may be dedicated to game content while content server 510B is dedicated to non-game content. The non-game content may include advertising content, entertainment content, promotions content, web content, etc. For example, content server 510B may be an advertising content server or an entertainment content server or a combination thereof.

As described above, the content may include images, symbols, indicia, etc. For example, the display devices are adapted to display visual representations or exhibitions of static objects or images as well as the movement of objects, video images, dynamic lighting, etc. Game content may include the display of one or more video reels, one or more video wheels, and/or one or more video dice.

The non-game content may be distinct and separate from the game content such that it is presented or displayed via a secondary application that has separate application files, separate functions, separate processor threads, separate data etc. whereas the game content may be presented or displayed via a primary application that is not changeable. However, the non-game content, such as the dynamic content may be updated by casinos (e.g., when switching between advertisements and other entertainment or when an advertising lease of space expires). For example, the game content may be subject to additional restrictions and controls than the non-game content.

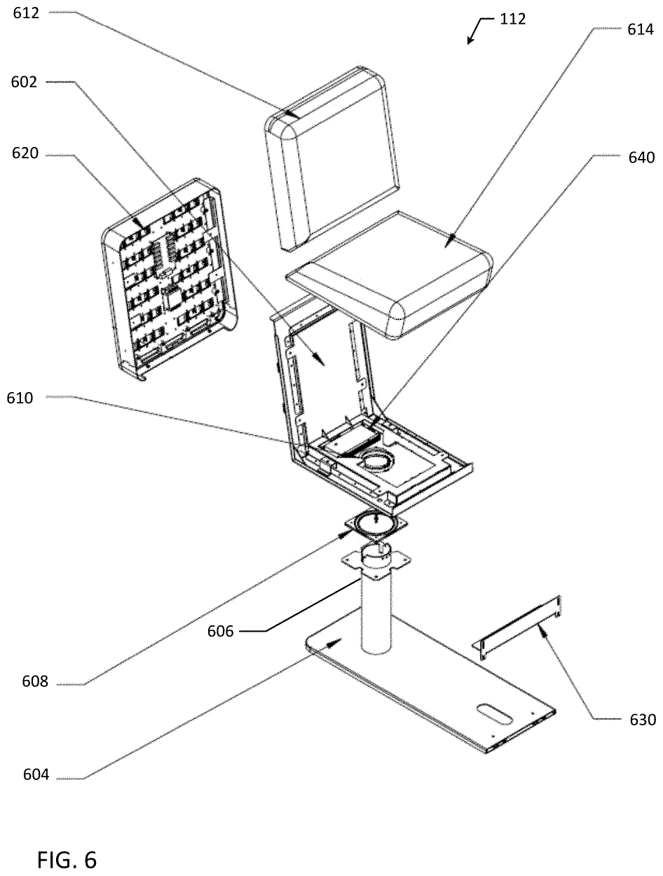

FIG. 6 illustrates an example embodiment of a game chair 112. The game chair 112 includes a frame 602 and a support plate 604 that is configured to connect to at least one of a floor (e.g., casino floor) or a game machine 110. In an example, the game chair 112 may be coupled to a game machine 110 via the support plate 604 and bracket 630. The support plate 604 may include a vertical seat mount 606 that is connected to the frame 602 by a swivel disc 608 and bushing 610. For example, the swivel disc 608 and bushing 610 may enable the game chair to rotate about the vertical seat mount 606.

In an example, both the backrest 612 and the seat 614 may be a cushion. Behind the backrest 612 is a light array 620 (e.g., LED light array) configured to illuminate the chair display. The frame 602 supports a backrest 610 and a seat 612. The frame 602 may also house a power supply 640. In an example, the power supply is an alternative current (AC) 300 W, 5V power supply. Besides the light array 620 configured to illuminate the chair display 160, the chair may also include other electronic comments such as speakers, light strips or light rings. The light strips or rings may be light emitting displays (LED) bars, marquee lights, string lights, etc. Additionally, each chair may include a projection laser that is configured to project images (e.g., content 320) on the floor or other nearby surfaces.

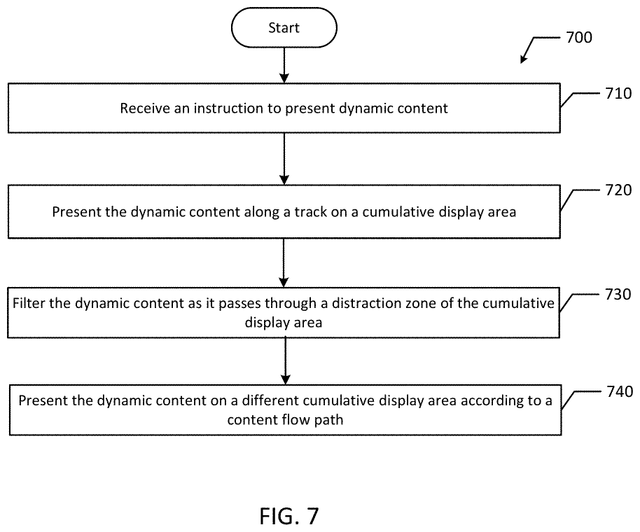

FIG. 7 illustrates a flowchart of an example method 700 for coordinating content display across multiple wagering game machines in accordance with an example of the present disclosure. Although the example method 700 is described with reference to the flowchart illustrated in FIG. 7, it will be appreciated that many other methods of performing the acts associated with the method 700 may be used. For example, the order of some of the blocks may be changed, certain blocks may be combined with other blocks, blocks may be repeated, and some of the blocks described are optional. The method 700 may be performed by processing logic that may comprise hardware (circuitry, dedicated logic, etc.), software, or a combination of both.

In the illustrated example, method 700 includes receiving an instruction present dynamic content (block 710). For example, a game machine 110 may receive an instruction to present dynamic content 320 from one or more servers (e.g., content server 510A-B and game machine server 512) or controller (e.g., network controller 514). In an example, each game machine 110 includes a processor 530 that is configured to transmit and receive data or signals (e.g., content data) representing instructions, commands, messages, etc. between the game machine 110 and the servers (e.g., content server 510A-B and game machine server 512) and/or controllers (e.g., network controller 514). Method 700 also includes presenting the dynamic content along a track on a cumulative display area (block 720). For example, dynamic content 320 may be presented along a track 330 on a first cumulative display area 350.

Additionally, method 700 includes filtering the dynamic content as it passes through a distraction zone of the cumulative display area (block 730). For example, the dynamic content 320 may be filtered as it passes through a distraction zone 345 of the first cumulative display area 350. In an example, a game machine 110 may include a filter module 552 that is configured to dim or reduce the brightness of the content 320 as it passes through the distraction zone 345. The method also includes presenting the dynamic content on a different cumulative display area according to a content flow path (block 740). For example, the dynamic content 320 may be presented on a second cumulative display area 350 according to a content flow path 402.

It will be appreciated that all of the disclosed methods and procedures described herein can be implemented using one or more computer programs or components. These components may be provided as a series of computer instructions on any conventional computer readable medium or machine readable medium, including volatile or non-volatile memory, such as RAM, ROM, flash memory, magnetic or optical disks, optical memory, or other storage media. The instructions may be provided as software or firmware, and/or may be implemented in whole or in part in hardware components such as ASICs, FPGAs, DSPs or any other similar devices. The instructions may be configured to be executed by one or more processors, which when executing the series of computer instructions, performs or facilitates the performance of all or part of the disclosed methods and procedures.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A gaming chair associated with a game machine, the gaming chair comprising:
a seat;
a backrest having a front surface and a rear surface, wherein the front surface faces a game machine; and
a first display positioned on the rear surface of the backrest, the first display configured to:
present first content on the first display at a first time, and
present second content on the first display at a second time, wherein the second content is coordinated with a second display of the game machine.

2. The gaming chair of claim 1, wherein the first content is static content.

3. The gaming chair of claim 1, wherein the second content is dynamic content.

4. The gaming chair of claim 1, wherein the dynamic content is player attraction material or an advertisement.

5. The gaming chair of claim 1, wherein the first display and the second display of the game machine form at least part of a cumulative display area, and wherein the second content follows a track within the cumulative display area.

6. The gaming chair of claim 1, wherein the first display and the second display of the game machine form at least part of a first cumulative display area, and wherein the second content follows a content flow path to a separate bank of game machines with a second cumulative display area to create a coordinated presentation of the content across the first cumulative display area and the second cumulative display area.

7. The gaming chair of claim 6, wherein the second content is presented on the second cumulative display area according to a positioned-based time delay associated with the separate bank of game machines.

8. A system comprising:
a first game machine of a plurality of game machines organized in a bank, the first game machine including a first main display;
a second game machine of the plurality of game machines organized in the bank, the second game machine including second main display;
an upper signage display;
at least one of a filler display, an edge display, and an end cap display; and
a first gaming chair associated with the first game machine, the first gaming chair including a chair display, wherein the chair display, the upper signage display and the at least one of the filler display, the edge display, and the end cap display form a first cumulative display area, wherein the first cumulative display area is configured to:
present first content at a first time, and
present second content at a second time, wherein the second content is coordinated with a second cumulative display area of a separate bank of game machines.

9. The system of claim 8, wherein the first content is static content.

10. The system of claim 8, wherein the second content is dynamic content.

11. The system of claim 8, wherein the second content follows a track on the first cumulative display area, wherein the first cumulative display area includes dead space, and wherein the track is configured to pass through less than a threshold amount of the dead space.

12. The system of claim 11, wherein the first cumulative display area includes a distraction zone, and the second content is filtered as it passes through the distraction zone.

13. The system of claim 12, wherein filtering the second content includes reducing the brightness of the second content.

14. The system of claim 8, wherein the second content is dynamic content that is presented on at least a portion of the second cumulative display area in a content direction according to a content flow path.

15. The system of claim 12, wherein the direction of the content flow path is determined based on a location of a winning event at a respective game machine.

16. The system of claim 8, wherein the second content is presented on the second cumulative display area according to a positioned-based time delay associated with the separate bank of game machines.

17. The system of claim 16, wherein the position-based time delay is configured by inputting positional spacing information of at least one of the game machines.

18. A method comprising:
receiving an instruction to present dynamic content;
presenting the dynamic content along a track on a first cumulative display area, wherein at least two of a chair display, a secondary display, an upper signage display, a filler display, and an end cap display form the first cumulative display area;
filtering the dynamic content as it passes through a distraction zone of the first cumulative display area; and
presenting the dynamic content on a second cumulative display area according to a content flow path.

19. The method of claim 18, wherein the first cumulative display area includes dead space, and the method further comprising determining the track such that the track is configured to pass through less than a threshold amount of the dead space.

20. The method of claim 18, further comprising determining a direction of the content flow path based on a location of a game event, and wherein the game event is a jackpot and the location is associated with a game machine associated with the jackpot.
